(19) United States
(12) Patent Application Publication
(10) Pub. No.: US 2013/0091376 A1
(43) Pub. Date: Apr. 11, 2013

(54) SELF-REPAIRING DATABASE SYSTEM

(71) Applicants: Steve RASPUDIC, Mississauga (CA); Matthew David Patrick Van Dijk, Markaham (CA)

(72) Inventors: Steve RASPUDIC, Mississauga (CA); Matthew David Patrick Van Dijk, Markaham (CA)

(73) Assignee: International Business Machines Corporation, Armonk, NY (US)

(21) Appl. No.: 13/253,904

(22) Filed: Oct. 5, 2011

(51) Int. Cl. G06F 11/08

(52) U.S. Cl. 714/3; 714/E11.03

(57) ABSTRACT

A method, system, and computer program product include generating a database copy from a database of a primary virtual machine (VM), provisioning a standby VM with the database copy, detecting a failure associated with the database, and promoting the standby VM to replace the primary VM.

### BACKGROUND

Relational database systems are increasingly being hosted on cloud-based platforms. When a node of a relational database system fails, a database administrator needs to provision a new node to replace the failed node. The provisioning includes configuring the new node, copying the database onto the new node, and integrating the new node into the database system. The existence of the failed node causes an increased load on the surviving nodes of the database system until the administrator can replace the failed node with the new node, and the repair duration may be relatively long, depending on the size of the database system. Such failures can cause undesirable results ranging from increased latency to random failure or outages, especially if a subsequent failure occurs before the failed node is replaced.

### SUMMARY

According to one embodiment, a method includes generating a database copy from a database of a primary virtual machine (VM), and provisioning a standby VM with the database copy. The method also includes detecting a failure associated with the database, and promoting the standby VM to replace the primary VM.

System and computer program products corresponding to the above-summarized methods are also described and claimed herein.

### BRIEF DESCRIPTION OF THE SEVERAL VIEWS OF THE DRAWINGS

FIG. 1 is a simplified diagram of an example cloud computing environment, according to one embodiment.

FIG. 2 is a simplified block diagram of an example hardware implementation of a computer system/server, according to one embodiment.

FIG. 3 is a simplified block diagram of an example environment for implementing embodiments described herein, according to one embodiment.

FIG. 4 is a simplified flowchart illustration of an example method, according to one embodiment.

FIG. 5 is a simplified flowchart illustration of an example method, according to another embodiment.

### DETAILED DESCRIPTION

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java® (Java, and all Java-based trademarks and logos are trademarks of Sun Microsystems, Inc. in the United States, other countries, or both), Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer special purpose computer or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified local function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

Embodiments optimize database systems by enabling efficient self-repairing of database systems in response failure events. In one embodiment, a self-repair application generates a database copy from a database of a primary virtual machine (VM) and provisions a standby VM with the database copy. Upon detecting a failure associated with the database (e.g., node failure, database failure, etc.), the self-repair application promotes the standby VM to a new primary VM to replace the failed primary VM. The self-repair process occurs in real-time without manual user intervention and without end users being aware of the failure and self-repair process.

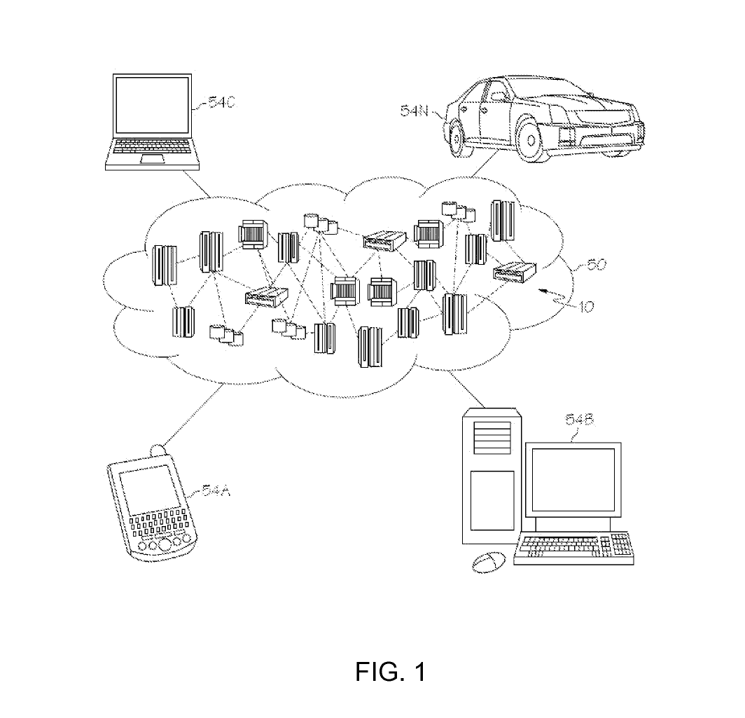

FIG. 1 is a simplified diagram of an example cloud computing environment 50, according to one embodiment. As shown, cloud computing environment 50 includes one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Cloud computing nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N are intended to be illustrative only and that computing nodes 10 and cloud computing environment 50 can communicate with any type of computerized device over any type of network and/or network addressable connection (e.g., using a web browser).

It is understood in advance that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure comprising a network of interconnected nodes.

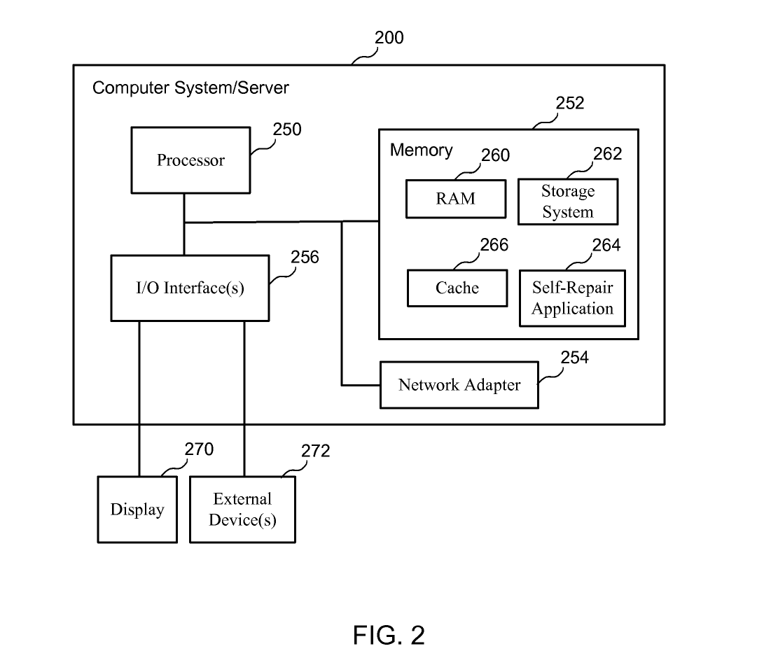

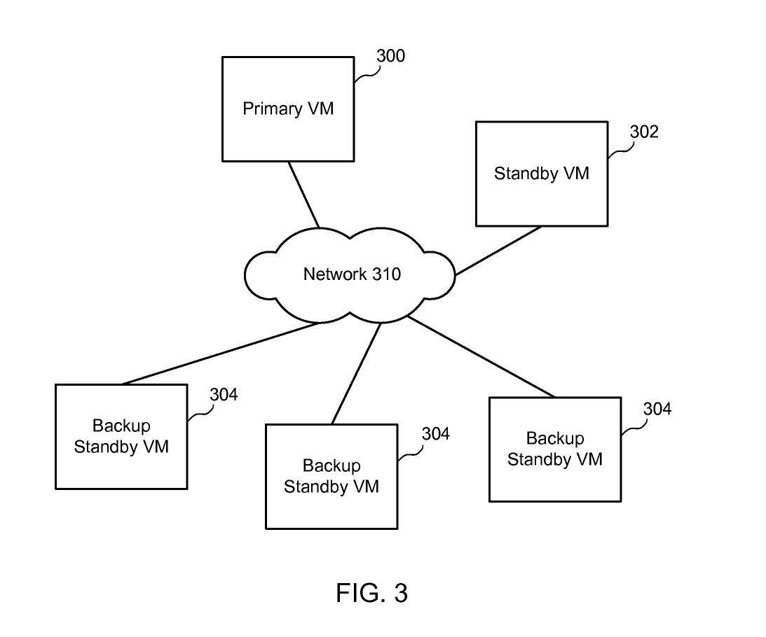

FIG. 2 is a simplified block diagram of an example hardware implementation of a computer system/server, according to one embodiment. Computer system/server 200 may be used to implement a VM such as any one or more VMs shown in FIG. 3. The components of computer system/server 200 may include, but are not limited to, one or more processors or processing units 250 and a system memory 252.

A bus couples various system components including system memory 252 to processor 250. The bus shown in FIG. 2 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system/server 200 typically includes a variety of computer system readable media. Such media may be any available media that is accessible by computer system/server 200, and it includes both volatile and non-volatile media, removable and non-removable media. The computer readable medium stores computer readable program code for implementing the methods and embodiments described herein. The processor executes the program code according to the various embodiments of the present invention.

System memory 252 can include computer system readable media in the form of volatile memory, such as random access memory (RAM) 260 and/or cache memory 266. Computer system/server 200 may further include other removable/non-removable, volatile/non-volatile computer system storage media. By way of example only, storage system 262 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus by one or more data media interfaces. As will be further depicted and described below, memory 252 may include at least one program product having a set (e.g., at least one) of program modules that are configured to carry out the functions of embodiments of the invention.

Self-repair application 264 is a software program/utility, that has a set (at least one) of program modules that may be stored in memory 252 (by way of example and not limitation), as well as an operating system, one or more application programs, other program modules, and program data. Each of the operating system, one or more application programs, other program modules, and program data or some combination thereof, may include an implementation of a networking environment. Program modules 42 generally carry out the functions and/or methodologies of embodiments of the invention as described herein.

Computer system/server 200 may also communicate with a display 270, and one or more external devices 272 such as a keyboard, a pointing device, etc., which enable a user to interact with computer system/server 200; and/or any devices (e.g., network card, modem, etc.) that enable computer system/server 200 to communicate with one or more other computing devices. Such communication can occur via I/O interfaces 256. Still yet, computer system/server 200 can communicate with one or more networks such as a local area network (LAN), a general wide area network (WAN), and/or a public network (e.g., the Internet) via network adapter 254. As depicted, network adapter 254 communicates with the other components of computer system/server 200 via the bus. It should be understood that although not shown, other hardware and/or software components could be used in conjunction with computer system/server 200. Examples, include, but are not limited to: microcode, device drivers, redundant processing units, external disk drive arrays, RAID systems, tape drives, and data archival storage systems, etc.

Computer system/server 200 may be used to implement any of the cloud computing nodes 10 shown in cloud computing environment 50 of FIG. 1. Cloud computing nodes 10 are only examples of a suitable cloud computing nodes and are not intended to suggest any limitation as to the scope of use or functionality of embodiments of the invention described herein. Regardless, cloud computing nodes 10 are capable of being implemented and/or performing any of the functionality set forth hereinabove.

Computer system/server 200 is operational with numerous other general purpose or special purpose computing system environments or configurations. Examples of well-known computing systems, environments, and/or configurations that may be suitable for use with computer system/server 200 include, but are not limited to, personal computer systems, server computer systems, thin clients, thick clients, hand-held or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system/server 200 may be described in the general context of computer system-executable instructions, such as program modules, being executed by a computer system. Generally, program modules may include routines, programs, objects, components, logic, data structures, and so on that perform particular tasks or implement particular abstract data types. Computer system/server 200 may be practiced in distributed cloud computing environments where tasks are performed by remote processing devices that are linked through a communications network. In a distributed cloud computing environment, program modules may be located in both local and remote computer system storage media including memory storage devices.

FIG. 3 is a simplified block diagram of an example environment for implementing embodiments described herein, according to one embodiment. FIG. 3 shows a primary VM 300, a standby VM 302, and backup standby VMs 304. VMs 300, 302, and 304 may be deployed in different types of database systems (e.g., relational databases, etc.) and cloud-based platforms (e.g., e-commerce cloud platforms, test and development cloud platforms, etc.). Embodiments described herein may apply to database systems in both public and private cloud-based platforms.

In one embodiment, each VM 300, 302, and 304 may be a VM having an IP address and storage (local or remote). In one embodiment, the storage system may be a shared-disk topology or a non-shared disk topology.

In one embodiment, the primary VM 300 and standby VM 302 may be on the same physical computer system/server 200. In various embodiments, the primary VM 300 and standby VM 302 are separated on different computer system/servers, and may also be separated on different cloud sites (e.g., different cloud zones). This ensures that the database system can withstand a cloud outage.

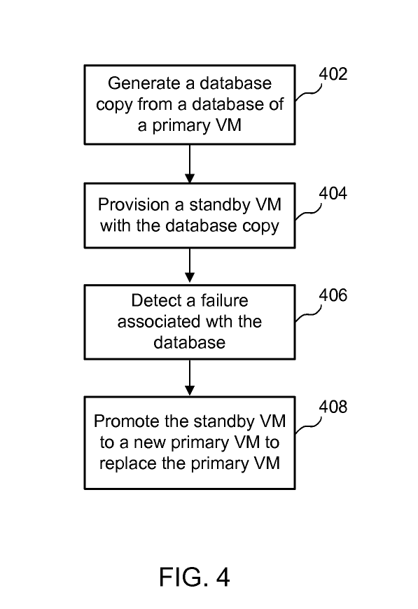

FIG. 4 is a simplified flowchart illustration of an example method of operation of the system of FIG. 3, according to one embodiment. As described in more detail below, in one embodiment, the method enables efficient self-repair of a database system in response to a failure event. Referring to FIGS. 2, 3, and 4 together, the process begins in block 402, where self-repair application 264 generates a database copy from a database of primary VM 300. In various embodiments, the database copy serves as backup copy for the database.

In block 404, self-repair application 264 provisions standby VM 302 with the database copy. In one embodiment, the provisioning involves configuring standby VM 302 and storing the database copy on standby VM 302. As described below, the provisioning enables standby VM 302 to function as a backup VM for primary VM 300 if primary VM 300 fails. In particular, the provisioning enables standby VM 302 to replace primary VM 300 in the event of a failure associated with the database. In one embodiment, self-repair application 264 continuously updates the database copy when the database changes such that the database copy that is stored on standby VM 302 is continuously updated. In one embodiment, the database copy is continuously updated by mirroring. In various embodiments, mirroring may be provided via transaction log based replication. In one embodiment, transactions that are generated at the database of primary VM 300 may be synchronously replicated over a TCP/IP link to a database of standby VM 302. Standby VM 302 receives the log records and ensures that the database of standby VM 302 is up to date transactionally with the database of primary VM 300.

In one embodiment, self-repair application 264 provisions multiple standby VMs 302. In one embodiment, self-repair application 264 provisions a new standby VM with the database copy whenever a failure associated with the database is detected. In one embodiment, self-repair application 264 provisions standby VM 302 in a cloud-based system. In one embodiment, the database copy includes the entire database, including configuration settings, states, code, operating system, and support data required to recover the database. In one embodiment, state information and data that are not a part of the database are not copied. In one embodiment, each VM is assigned a fixed IP address and fixed external host name. As such, the IP address for a given VM does not change from a client perspective.

In block 406, self-repair application 264 detects a failure associated with the database. In one embodiment, self-repair application 264 may detect failures using heart beat mechanisms among VMs in order to detect failures. In various embodiments, failures may include but are not limited to hardware failures, software failures, operating system failures, database failures, power-related failures, responsiveness issues, login problems, etc.

In block 408, self-repair application 264 promotes standby VM 302 to a new primary VM to replace failed primary VM 300. In one embodiment, the database copy stored on the new primary VM replaces the failed database.

In one embodiment, to promote standby VM 302 to a new primary VM, self-repair application 264 may perform the following steps. After self-repair application 264 detects a failure associated with a primary VM (e.g., an outage event associated with primary VM 300), the database of standby VM 302 is taken out of its role as a replica (e.g., a backup). At this time, in one embodiment, a procedure is initiated to provision a new standby VM to replace standby VM 302. In one embodiment, after standby VM 302 is promoted, the previous primary VM (e.g., primary VM 300) is deleted. In one embodiment, data associated with the previous primary VM is deleted from the system and all resources consumed by previous primary VM are released back to the system.

In one embodiment, self-repair application 264 may include software modules. For example, self-repair application 264 may include an event detection software module to detect failures. Self-repair application 264 may also include an event action software module for executing provisioning steps. In various embodiments, self-repair application 264 may reside on each of primary VM 300 and standby VM 302.

In one embodiment, self-repair application 264 determines the current configuration of the database system, in which primary VM 300 and standby VM 302 are implemented, and integrates the standby VM 302 into the database system using the determined configurations in order to replace the failed primary VM 300 in the event of a failure.

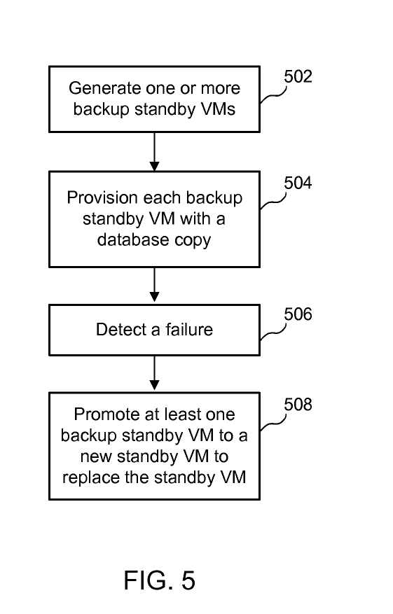

For ease of illustration, one failure is described in block 406. In some scenarios, multiple failures may be detected, in which case self-repair application 264 will promote multiple standby VMs 302 to new primary VMs 300. In various embodiments, if only one standby VM 302 is provisioned at the time of multiple failures, self-repair application 264 will automatically provision and promote backup standby VMs 304 to new standby VMs. Backup standby VMs are described in more detail below in connection with FIG. 5.

FIG. 5 is a simplified flowchart illustration of an example method of operation of the system of FIG. 3, according to another embodiment. As described in more detail below, in one embodiment, the method enables efficient self-repair of a database system in response to one or more failure events associated with a database and/or a database copy. Referring to FIGS. 2, 3, and 5 together, the process begins in block 502, where self-repair application 264 generates one or more backup standby VMs 304. In one embodiment, self-repair application 264 provisions each backup standby VM 304 with a database copy. In one embodiment, self-repair application 264 provisions each backup standby VM 304 with a database copy whenever a failure associated with the database of the primary VM 300 is detected or whenever a failure associated with the database copy of the standby VM 302 is detected.

Generating multiple backup standby VMs 304 proactively minimizes any vulnerability caused by a failure, whether the failure is associated with the database of primary VM 300 or the backup database of standby VM 302. As such, even as the database system grows, the number of backup standby VMs 304 may also grow accordingly in order to accommodate possible failures or series of failures associated with the database of primary VM 300 or the backup database of standby VM 302. The particular number of backup standby VMs 304 (e.g., 4 backup standby VMs) generated and provisioned may vary and will depend on the specific implementation.

In block 504, self-repair application 264 provisions each backup standby VM 304 with a database copy. The provisioning includes storing the database copy on the standby VM 302.

In block 506, self-repair application 264 detects a failure. As indicated above, the failure may be associated with the database of the primary VM 300 or the database copy of standby VM 302. In various embodiments, failures associated with the database copy of the standby VM 302 may occur independently of failures associated with the database of the primary VM 300.

In block 508, self-repair application 264 promotes the backup standby VM 304 to a new standby VM to replace standby VM 302. In one embodiment, when self-repair application 264 promotes a given standby VM 302 to primary VM 300, self-repair application 264 may also promote one or more backup standby VMs 304 to standby VMs. Self-repair application 264 may also generate and provision new backup standby VMs to replace the backup standby VMs 304 that were promoted to standby VMs. In other words, while a failure may trigger one or more promotions, a given promotion may also trigger one or more other promotions. Self-repair application 264 may perform these promotions synchronously or asynchronously. As such, self-repair application 264 proactively replaces failed primary VMs and proactively provisions new standby VMs and backup standby VMs in order to efficiently respond to future failures or a series of failures.

Embodiments described herein handle single VM failures and successive VM failures automatically and efficiently, which ensures healthy database systems. Embodiments ensure continuous availability of data and database system resources to end users regardless of any single hardware or software failures or series of such failures. Embodiments eliminate manual user intervention and perform repairs without end users being aware of the failures or self-repair processes. Embodiments ensure high availability of a database system being hosted in a cloud environment. Embodiments provide a needed degree of redundancy of databases. Embodiments minimize the cost and complexities of database system failures. Embodiments minimize database system outages.

The descriptions of the various embodiments of the present invention has been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

1. A method comprising:
generating, by a processor, a database copy from a database of a primary virtual machine (VM);
provisioning, by the processor, one or more standby VM, comprising storing the database copy on the standby VM and continuously updating the database copy when the database changes such that the database copy stored on the standby VM is continuously updated;
provisioning, by the processor, one or more backup standby VM comprising storing the database copy on the backup standby VM;
after provisioning the standby VM and the backup standby VM, detecting, by the processor, a failure associated with the database; and
in response to detecting the failure, automatically promoting, by the processor, the standby VM to replace the primary VM and the backup standby VM to replace the promoted standby VM, and provisioning another backup standby VM to replace the promoted backup standby VM.

2. The method of claim 1, further comprising:
determining a current configuration of a database system in which the primary VM and the standby VM are implemented; and
integrating the standby VM into the database system using the determined configurations in order to replace the primary VM.

3.-7. (canceled)

8. A computer program product for implementing a self-repairing database system, the computer program product comprising:
a computer readable storage device having computer readable program code embodied therewith, the computer readable program code configured to:
generate a database copy from a database of a primary virtual machine (VM);
provision one or more standby VM comprising storing the database copy on the standby VM and continuously updating the database copy when the database changes such that the database copy stored on the standby VM is continuously updated;
provision one or more backup standby VM comprising storing the database copy on the backup standby VM;
after provisioning the standby VM and the backup standby VM, detect a failure associated with the database; and
in response to detecting the failure, automatically promote the standby VM to replace the primary VM and the backup standby VM to replace the promoted standby VM, and provisioning another backup standby VM to replace the promoted backup standby VM.

9. The computer program product of claim 8, further comprising:
determining a current configuration of a database system in which the primary VM and the standby VM are implemented; and
integrating the standby VM into the database system using the determined configurations in order to replace the primary VM.

10.-14. (canceled)

15. A system comprising:
a processor; and
a computer readable storage device having computer readable program code embodied therewith, the computer readable program code which when executed by the processor executes a method comprising:
generating a database copy from a database of a primary virtual machine (VM);
provisioning one or more standby VM comprising storing the database copy on the standby VM and continuously updating the database copy when the database changes such that the database copy stored on the standby VM is continuously updated;
provisioning one or more backup standby VM comprising storing the database copy on the backup standby VM;
after provisioning the standby VM and the backup standby VM, detecting a failure associated with the database; and
in response to detecting the failure, automatically promoting the standby VM to replace the primary VM and the backup standby VM to replace the promoted standby VM, and provisioning another backup standby VM to replace the promoted backup standby VM.

16. The system of claim 15, further comprising:
determining a current configuration of a database system in which the primary VM and the standby VM are implemented; and
integrating the standby VM into the database system using the determined configurations in order to replace the primary VM.

17.-25. (canceled)
